(19) United States
(12) Patent Application Publication
(10) Pub. No.: US 2015/0052514 A1
(43) Pub. Date: Feb. 19, 2015

(54) METHOD AND COMPUTER SYSTEM OF DISTRIBUTING A COMPUTER PROGRAM PRODUCT

(71) Applicant: PROPELLERHEAD SOFTWARE AKTIEBOLAG, Stockholm (SE)

(72) Inventor: Marcus Zetterquist, Stockholm (SE)

(73) Assignee: PROPELLERHEAD SOFTWARE AKTIEBOLAG, Stockholm (SE)

(21) Appl. No.: 14/386,985

(22) PCT Filed: Mar. 15, 2013
(86) PCT No.: PCT/SE2013/050265

§ 371 Date: Sep. 22, 2014

Related U.S. Application Data
(60) Provisional application No. 61/617,366, filed on Mar. 29, 2012.

(30) Foreign Application Priority Data
Mar. 20, 2012 (SE) 1250267-0

(51) Int. Cl. G06F 9/445; G06F 9/45

(52) U.S. Cl. CPC G06F 9/44526; G06F 8/41
USPC 717/177

(57) ABSTRACT

In a method of distributing an extension module for a host data program, the extension module is arranged to cooperate with and extend the functionality of the host data program. Source code is provided for the extension module, the source code being arranged so as to be compiled to executable code, and the source code is independent of the platform in which the executable code is to be executed. A first compilation step is performed on the source code to provide the extension module in an intermediate format, the intermediate format also being independent of the platform in which the executable code is to be executed. A vendor stores the extension module in the intermediate format, so that the stored extension module can be compiled to machine-executable format at a later stage.

### BACKGROUND OF THE INVENTION

1. Field of the Invention

The present invention relates to a method of distributing a computer program product.

2. Description of the Prior Art

Computer programs are written as source code and compiled to executable code (machine code or object code). When distributing a program typically the executable code is delivered so that the customer gets a functional product without getting any insights into the structure or design of the program. In other cases, in particular regarding open source programs, the source code is also made available.

A number of programs use additional extension modules for enhancing the functionality of the host program. One form of such extension modules is called plugins. For example, a number of plugins are available for Adobe Photoshop, for providing additional image effects or performing tasks that are impossible or difficult to perform using only the functionality provided by the program itself. In this document the term “host program extension module” or “extension module” will be used to denote program modules provided for enhancing or extending the functionality of a host program.

Typically extension modules such as plugins are also a way for 3^{rd} party developers to add functions to a host program. For this purpose, the host program provides services which the extension module can use, including a way for plug-ins to register themselves with the host program and a protocol for the exchange of data with extension modules. It is possible to create extension modules in many different programming languages, for example C, C++, Delphi, Java and others.

Extension modules are delivered to the end user as machine code, adapted and compiled to the particular environment on which they are to run. For example, different versions are needed for different operating systems, or for different versions of an operating system and for different microprocessor architectures.

Taking C++ as an example, plugins written in C++ are often delivered as dynamically-linked libraries. On Windows these are called .dll files, on Mac OS X they are called dylib. These files are obtained by compiling C++ code and are typically made available in different formats, each adapted to a particular environment, such as operating system and microprocessor architecture.

Hence, a number of machine code files need to be provided and these files cannot be adapted later on. Therefore, they cannot always be used with new versions of operating systems and will not work on another microprocessor architecture.

### SUMMARY OF THE INVENTION

The invention aims at making host program extension modules future proof.

This object is achieved by a method of distributing an extension module for a host data program, said extension module being arranged to cooperate with and extend the functionality of the host data program, said method comprising the following steps:

providing a source code for the extension module, said source code being arranged to be compiled to executable code, and said source code being independent of the platform on which the executable code is to be executed;

performing a first compilation step on the source code to provide the extension module in an intermediate format, said intermediate format being independent of the platform on which the executable code is to be executed;

storing by a vendor the extension module in the intermediate format so that it can be compiled to machine executable format at a later stage.

The invention also relates to a computer system comprising a first memory repository arranged to hold computer programs in the form of extension modules that are to be distributed on demand. The computer programs are stored in the memory repository in an intermediate format, said intermediate format being compiled from source code and being independent of the platform on which the executable code is to be executed, and the computer system also comprises compilation software for compiling the extension modules to intermediate format into machine executable code.

By storing the extension modules in the intermediate, platform independent format they can be compiled to executable code at any stage after delivery to the vendor, even long after the code was written. Therefore, they can be adapted to new computer environments long after the code was written. New computer environments may be computer environments that have emerged, or been changed at a later stage, or that were previously existing but for which the extension modules were not adapted. In the context of the invention a computer may be a standard computer or any other type of computing device, such as a computer game terminal, a mobile telephone, Ipad, etc. Also, it may be a dedicated device such as a sound synthesizer.

The invention is based on the insight that for many programming languages at one point along the compilation sequence a general format is available. As the name indicates, this is only intended as an intermediate stage in the compilation, which is normally just processed further and not stored. For example, for C++, and for some other languages, the LLVM compiler may be used. This compiler compiles in a number of stages, an intermediate stage being IR or intermediate representation. Hence, for C++ programs the intermediate, platform independent format may be the Intermediate Representation (IR) format.

The solution according to the invention is based on the insight that this intermediate format may be stored for the future and the last part of the compilation sequence may be finished at a later stage to provide machine code. In this way, machine code may be automatically compiled to any future or additional environment, also to types of computers or operating systems that had not been developed at the time of developing the original code.

The host program may be any type of program and the extension modules may be any type of extension modules arranged to provide additional functionality to the host program. In a preferred embodiment, however, the extension module is arranged to provide real-time functionality, such as generating or manipulating an audio or video stream.

In a preferred embodiment, the extension modules are prevented from interacting directly with the operating system. Instead, the host program supplies a toolbox for use by the extension modules. Extension modules are stopped from using any features in the environment; only the functions provided by the toolbox are allowed. This means that the extension module becomes independent on the operating system and microprocessor architecture (x86 32 bit, X86 64-bit, PowerPC, ARM etc.). It also serves to protect the user and host program from harmful extension modules.

During compilation the extension module is also checked for commands that may be harmful, for example commands that try to access the environment, bypassing the toolbox provided by the host program. This achieves the additional advantage of increased isolation of different program modules from each other, known as “sandboxing”. This means that an extension module can only use functions that are provided by the host program. For example, the extension module cannot itself order a file to be opened; it can only request that the host program opens the file. The sandboxing also contributes to making the extension module future-proof, since the limited possibilities for interaction with the environment makes it easier to adapt it to new environments.

The source code for the extension module will normally be provided by a 3^{rd} party developer separate from the vendor. Typically, but not necessarily, the first compilation step is performed by the same party that provides the source code. It may of course also be performed by the vendor, or by someone else. The method preferably comprises the step of performing a second compilation step on the extension module in the intermediate format to provide the extension module as executable code for at least one particular platform.

In a preferred embodiment the method comprises a number of security checks to ensure that the extension module does not have any harmful code. These security checks may include one or more of the following:

Statically validating that the extension module does not call any code except code provided by host program for communicating with the extension module.

During runtime the system checks the CPU clock cycle consumption by each extension module to ensure that it does not exceed a certain limit. This prevents against the program staying in an eternal loop and also prevents against malicious or badly written code.

Checking before each memory read or write to ensure that the extension module communicates only through the host program.

The toolbox has strict contracts with all extension modules, and the contracts are enforced at runtime by careful validation of extension module's toolbox use.

The important state is kept in the host program and all attempts to make modifications by the extension module, are carefully validated via the toolbox.

The host program uses operating system features to detect runtime problems, like divide by zero, hardware exceptions and so on.

The first memory repository is arranged to hold extension modules written in a programming language such as C++ and compiled to the Intermediate Representation (IR) format or the equivalent format for another language. The computer system preferably also comprises a second memory repository arranged to hold extension modules compiled into machine executable code.

The invention also relates to a method of distributing and at least one extension module for a host program from a vendor to an end user, the vendor being arranged to store the at least one extension module in in a platform independent format that is intermediate between source code and machine executable code comprising the steps of

On request from the end user, providing to the end user a version of the host program adapted to the computer environment used by the end user

Preferably, the host program examines computer and operating system etc. and communicates this information to vendor (server), to allow vendor to select or compile the best version of the extension module. Alternatively, this information is provided by the user.

Providing the at least one extension module to the end user in the determined suitable machine executable format

This aspect of the invention enables the automatic provision of extension modules in the appropriate format to any given end user at any given time. The same end user can use the host program and extension modules from a number of different computer environments and still always have the correct version for the computer environment currently used.

The version of the host program may be selected based on input provided by the end user, or automatically based on data retrieved from the end user's computer.

In this document, the term “vendor” will be taken to mean the party providing the extension module or modules to an end user. This will typically be the same party that provides the host program, but it may also be an independent party. The end user is the party actually using the host program with one or more extension modules. The 3rd party is the party developing the source code for the extension module, usually a party that is independent from the vendor. Typically, the vendor has an interne server that automatically performs the work.

### BRIEF DESCRIPTION OF DRAWINGS

The invention will be described in more detail in the following, with reference to the appended drawings, in which

FIG. 1 is an overview of the sites that are involved in different phases of the method according to the invention

FIG. 2 is a flowchart of the development of programs according to an embodiment of the invention

FIG. 3 is a flowchart of the distribution of programs to the end user according to an embodiment of the invention.

FIG. 4 shows schematically the interface between the host program 10 and an extension module 12.

### DETAILED DESCRIPTION OF INVENTION

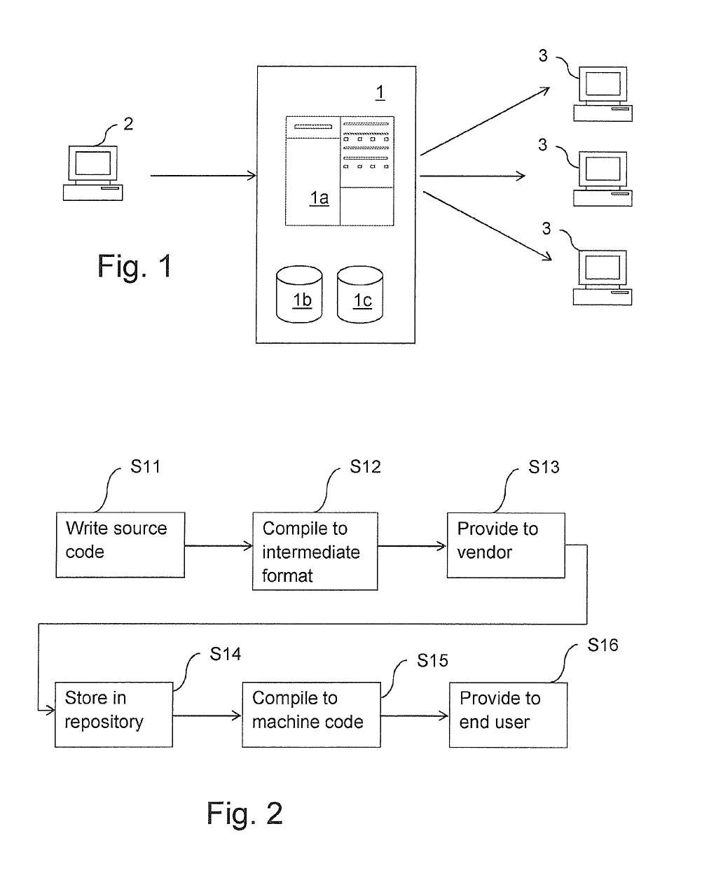

FIG. 1 is an overview of the parties that may be involved in different phases according to a preferred embodiment of the invention. In the middle the vendor 1 of the host program is located, represented by a server 1a and a database 1b. Typically, however, this site comprises one or more memories arranged to hold computer programs in different stages of compilation, as will be discussed in the following. One memory comprises the host program, which is any kind of program that may be enhanced using host program extension modules, for example a music generating program, an image processing program, or an interne browser.

On the left there are one or more developers 2 of extension modules or plugins to be used to enhance the functionality of the host program. The developers are represented by a simple computer. In reality, of course, they may have any suitable computer equipment. The developers may be working independently of each other or in cooperation, but they must work according to the guidelines provided by the vendor of the host program to make sure that the extension modules will function together with the host program. These extension modules are delivered from the developers to the vendor in the form of source code or in an intermediate format that is not compiled so far as to be executable, and that is still platform independent. If the extension modules are delivered in source code they will be compiled to the intermediate format at the vendor's site. The program files in the intermediate format are stored in a memory at the vendor's site.

On the right there are a number of end users 3 using the host program. The end users may have different types of equipment on which the host program is run, although FIG. 1 shows schematically a computer for each user. The program may be run or any type of computer or processing device, including devise that are not normally considered to be computers, such as sound synthesizers. According to the invention, also each end user is able to run the host program on a number of different computers platforms, different operating systems etc. Each end user may at some point obtain one or more extension modules for the host program and should be able to run the extension modules in the different computer environments.

The vendor makes the host program, and normally a number of extension modules, available to the end users. The vendor may be the firm developing the host program, or another party. There may be several vendors providing the same host program and/or extension modules. Also, one vendor may provide several host programs, which may each have associated extension modules.

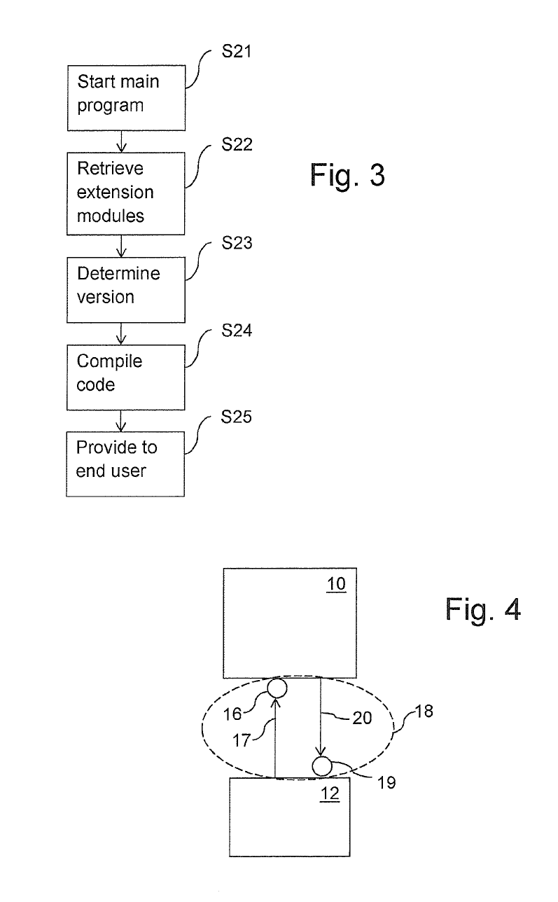

According to the invention this is achieved in that all or some of the extension modules are retrieved from the vendor's site when they are needed. Typically they will be retrieved if they are not available to the end user, or if the versions found on the end user's computer are old or of the wrong format. A flowchart of this procedure is shown in FIG. 3. In one embodiment, when the user retrieves the program and/or the extension modules, the vendor's site automatically provides the correct version for the user's computer environment. To do this the vendor must have, or be given, information about the user's computer environment. Software logic at the vendor's site then selects the appropriate version of each software module and provides it to the end user. This may comprise the step of compiling the intermediate version of each module to executable code adapted for the user's environment. Alternatively, a number of different formats may be stored at the vendor's site to begin with, in which case the software logic merely selects the appropriate version and provides it to the end user.

In this way each end user can have the software delivered in a format adapted to the computer hardware, operating system etc. that they use. An end user that uses the software in different computer environments can have the version adapted to the computer environment currently used. For example, if the end user uses one particular computer environment, say a Windows based environment, at home, and a different, environment, such as an Apple computer at work, when he logs in from his home computer, Windows adapted versions will be loaded, and when he logs in from his work computer MAC adapted versions will be loaded. Similarly if the user upgrades his Windows computer, software versions adapted for the new Windows OS will be provided.

Also, when new versions of a computer environment, or completely new computer environments, are developed, the corresponding compilers and versions of the host program can be made available at the vendor's site, so that the extension modules can be provided in versions suitable for the new environments, even for environments that were not available, or even conceived, when the software was developed. This is achieved since the intermediate code is stored at the vendor's site. Of course, it can also be used to make the extension modules available for computer environments for which they have not been previously available even if the computer environments are not new per se.

FIG. 2 is a flowchart of the development and distribution of programs such as extension modules according to the invention.

In step S11 a source code for a program is provided, normally from a third party provider. The program is preferably an extension module, such as a plugin, as discussed above. The source code may for example be written in C++ or in any other program that can be compiled to an intermediate format that is not executable but is platform independent and can be compiled further to produce executable code.

In step S12 the source code is compiled to an intermediate format as defined in S1.

In step S13 the extension module in the intermediate format is provided to a vendor of programs. Usually, in addition to the actual code there will be additional files such as graphics, scripts and/or lists, as is common in the art. If the program is an extension module for use with a host program, the receiving vendor may be the vendor of the host program. It may also be a separate party, providing one or more extension modules for the host program.

In step S14 the extension module is stored in the intermediate format in a file repository from which it can be retrieved at any time, even months or years later, and compiled further to a machine executable format. Preferably this file repository belongs to the vendor as discussed in step S13.

In step S15 the extension module is compiled from the intermediate format to the machine code format.

In step S16 the machine executable format is distributed to at least one client. Alternatively, or in addition, it may be stored in a second file repository, for storing machine executable programs.

In this way, a repository of machine code of extension modules corresponding to the most frequently used computer environments may be kept so that the compilation to machine code does not have to be performed every time. This may be done the first time a user requests the extension module for a particular computer environment, or beforehand.

Instead of compiling the source code to intermediate format before delivery to the vendor, it would be possible to deliver the source code to the vendor and compile to intermediate format afterwards. That is, the order of steps S12 and S13 could be reversed. It would also be possible to deliver the intermediate code to the end user and compile to machine code afterwards, that is, to reverse the order of the steps S15 and S16. Theoretically, of course the intermediate code or the source code itself could be delivered directly from the 3^{rd} party provider to the end user who would then compile it to a version suitable for his computer environment. This would, however, limit the possibility of safety checking the extension module and therefore might be less appropriate.

FIG. 3 is a flowchart of the distribution of an extension module from the vendor to the end user.

In step S21 the end user starts the host program, for example a photo editing program on his computer. The computer can be any kind of computing device that is capable of running the program, including personal computers, smartphones, and devices such as music synthesizers, that are not commonly thought of as computers but contain processors and memories enabling them to function.

In step S22 the computing device contacts the vendor's site to retrieve the program and extension modules. The computing device includes the necessary information about its hardware and software environment to enable the vendor's site to select the appropriate version of the program and extension modules. The information may be provided automatically by the computer or may be entered manually, for example by the user selecting a version for a Windows or Mac operating system, or for the desired mobile platform.

In step S23, which is an optional step, the vendor's site determines if versions of the program modules that are suited to the end users computer environment are available. If not the procedure continues with step S24; if they are available, the procedure continues with step S25.

Step S24: the intermediate versions of the desired program modules that are stored at the vendor's site are compiled using the appropriate version of the compiler to provide versions of the desired programs modules that are adapted to the end user's computer environment.

Step 25: the appropriate versions of the program modules are provided to the end user's computer so that the end user can run the program.

As will be understood, this procedure enables the end user to switch computer environments as often as desired.

FIG. 4 shows schematically the interface between the host program 10 and an extension module 12. Of course, there may be any number of extension modules cooperating with the host program, although only one is shown in FIG. 4.

The host program has an application programming interface API 18 to which an extension module is connected. The API (Application Programming Interface) is the contract between the two companies and the two pieces of software. It needs to be very carefully documented and machine-verified as much as possible both at compile time and at runtime. The API comprises two major parts. The first part is the above mentioned toolbox 16, which can be called by an extension module and will provide to the extension module 12 the tools it needs to communicate with the host program 10. This is indicated in FIG. 4 by an arrow 17 pointing from the extension module 12 to the toolbox 16 which is shown as closely associated with the host program 10. Preferably the extension module 12 is very limited in how it may interact with the environment, as will be discussed in the following. The second part consists of the exported functions 19, that is, the functions required to be exported by an extension module, which may be called by the host program. This is indicated in FIG. 4 by an arrow 20 pointing from the host program 10 to the exported functions 19.

Different version of the API can exists. A host program may support mixing of extension modules using different versions of the API at the same time. The host toolbox allows the extension module to request operations from the host program it cannot directly implement itself These are the only features the extension module can use, except those it contains itself. Examples would be: queries for extension module to access user-settings in the host program, or to modify the user's document as a result of the extension module's work.

The extension module's exported functions are called by the host program to make the extension module perform the unique operations it is designed to provide. This is indicated in FIG. 4 by an arrow 20 pointing from the host program 10 to the extension module 12. Examples could be: startup of extension module, closing of extension module, or asking the extension module to perform work on a part of the host program's data.

To ensure that an extension module does not harm the host program, or other extension modules, several restrictions are preferably placed on what the extension modules are allowed to do.

The extension module code may not call any outside code, only toolbox provided by host application.

The extension module code should not enter into any endless loops.

The number of resources, such as memory or CPU cycles that the extension module is allowed to consume is restricted, The extension module should not be allowed to read or write directly to the end user's computer.

The extension module should not be allowed to access the environment directly.

The extension module should not be allowed in any way to corrupt the state of the host program.

For security, preferably all extension modules that are stored in the file repository in step S14 above are preferably checked for code that may be harmful to the host program and/or other extension modules, or to the computer environment on which it is run. Preferably this is checked during initial testing, such as when the extension module is delivered to the vendor, to avoid time-consuming tests when the end user is waiting. This check includes one or more of the following steps, preferably all of them:

Server tools statically validates, in automatic or scripted tests of the extension module, that extension module code does not call any outside code, only toolbox provided by host application.

During runtime the system checks the number of CPU cycles consumed by each extension module to ensure that it does not exceed a certain limit. This prevents against the program staying in an eternal loop and also prevents against malicious or badly written code.

Extension module code may be configured to check before each memory read or write to ensure that the extension module does not bypass the toolbox and communicates directly with the computer's memory or environment.

The toolbox has strict contracts with all extension modules.

The important state is kept in the host program and all attempts by the extension module to make modifications, are carefully validated via the toolbox.

Host application uses operating system features to detect runtime problems, like divide by zero, hardware exceptions and so on.

If an extension module violates any of the above requirements, the host program may be arranged to shut the extension module down. Alternatively, the host program may be arranged to shut itself and all extension modules down in this case. Preferably this is done without causing problems to the end user. Most importantly end user must not lose important work or be harmed in other ways.

Although modifications and changes may be suggested by those skilled in the art, it is the intention of the inventor to embody within the patent warranted heron all changes and modifications as reasonably and properly come within the scope of his contribution to the art.

I claim as my invention:

1. A method of distributing an extension module (12) for a host data program (10), said extension module (12) being arranged to cooperate with and extend the functionality of the host data program (10), said method comprising the following steps:
providing a source code for the extension module, said source code being arranged to be compiled to executable code, and said source code being independent of the platform on which the executable code is to be executed;
performing a first compilation step on the source code to provide the extension module in an intermediate format, said intermediate format being independent of the platform on which the executable code is to be executed; and
storing by a vendor the extension module in the intermediate format so that it can be compiled to machine executable format at a later stage.

2. A method according to claim 1, further comprising the step of:
performing a second compilation step on the extension module in the intermediate format to provide the extension module as executable code for at least one particular platform

3. A method according to claim 1, wherein the step of providing the source code is performed by a 3^{rd} party developer separate from the vendor.

4. A method according to claim 1, wherein the first compilation step is performed by the same party that provides the source code.

5. A method claim 1, wherein the vendor is also the vendor of the host data program.

6. A method according to claim 1, further comprising checking the extension module for harmful code, the checking including performing one or more of the following tests:
statically validating that the extension module does not call any code except code provided by host program for communicating with the extension module;
during runtime the system checks the CPU clock cycle consumption by each extension module to ensure that it does not exceed a certain limit. This prevents against the program staying in an eternal loop and also prevents against malicious or badly written code;
checking before each memory read or write to ensure that the extension module communicates only through the host program;
the toolbox has strict contracts with all extension modules, and the contracts are enforced at runtime by careful validation of extension module's toolbox use;
the important state is kept in the host program and all attempts by the extension module to modify it are carefully validated via the toolbox; and
the host program uses operating system features to detect runtime problems, like divide by zero, hardware exceptions and so on.

7. A computer system comprising a first memory repository arranged to hold computer programs in the form of extension modules that are to be distributed on demand, said computer programs being stored in the memory repository in an intermediate format, said intermediate format being compiled from source code and being independent of the platform on which the executable code is to be executed; the computer system comprising compilation software for compiling the extension modules to intermediate format into machine executable code.

8. A computer system according to claim 7, wherein the first memory repository is arranged to hold extension modules written in C++ and compiled to the Intermediate Representation (IR) format.

9. A computer system according to claim 7, further comprising a second memory repository arranged to hold extension modules compiled into machine executable code.

10. A computer system according to claim 7, wherein the extension modules are arranged to perform a real-time function such as an audio or video function.

11. A method of distributing and at least one extension module for a host program from a vendor to an end user, the vendor being arranged to store the at least one extension module in in a platform independent format that is intermediate between source code and machine executable code comprising the steps of
on request from the end user, providing to the end user a version of the host program adapted to the computer environment used by the end user;
determining a suitable format for the extension module based on the version of the host program provided to the end user; and
providing the at least one extension module to the end user in the determined suitable machine executable format.

12. A method according to the claim 11, comprising selecting the version of the host program based on input provided by the end user.

13. A method according to the claim 11, comprising selecting the version of the host program automatically based on data retrieved from the end user's computer.
